(19) United States
(12) Patent Application Publication
(10) Pub. No.: US 2024/0201701 A1
(43) Pub. Date: Jun. 20, 2024

(54) SYSTEM AND METHOD OF RELATIVE NAVIGATION IN A NETWORK OF MOBILE VEHICLES

(71) Applicant: Aloft Sensing, Inc., Ann Arbor, MI (US)

(72) Inventors: Patrick Rennich, Ann Arbor, MI (US); Lauren Wye, Palo Alto, CA (US)

(73) Assignee: Aloft Sensing, Inc., Ann Arbor, MI (US)

(21) Appl. No.: 18/586,011

(22) Filed: Feb. 23, 2024

Related U.S. Application Data
(63) Continuation-in-part of application No. 17/484,176, filed on Sep. 24, 2021, now Pat. No. 11,933,883.

(51) Int. Cl. G05D 1/249; G05D 1/242; G05D 1/245; G05D 1/248; G05D 1/69; G05D 111/20; G05D 111/30

(52) U.S. Cl. CPC G05D 1/249; G05D 1/242; G05D 1/245; G05D 1/69; G05D 1/248; G05D 2111/20; G05D 2111/30

(57) ABSTRACT

A self-contained, high precision navigation method and system for a mobile vehicle includes an active coherent imaging sensor array with multiple receivers that observes the surrounding environment and a digital processing component that processes the received signals to form interferometric images and determine the precise three-dimensional location and three-dimensional orientation of the vehicle within that environment. A mesh navigation system for a network of mobile vehicles is provided where each mobile vehicle hosts an active coherent imaging sensor that observes a common area in the environment that surrounds the network of mobile vehicles. The navigation system on each mobile vehicle receives signals from the other mobile vehicles reflected from the common area in the environment. These signals are processed onboard each mobile vehicle to form interferometric images and determine the precise three-dimensional location of each mobile vehicle relative to the others operating and moving within the network.

### CROSS-REFERENCE TO RELATED APPLICATIONS

This application is a continuation-in-part of U.S. application Ser. No. 17/484,176, filed Sep. 24, 2021.

### BACKGROUND OF THE INVENTION

### (1) Field of the Invention

The present disclosure relates generally to precision navigation and positioning systems. More specifically, the present disclosure relates to a method and system for self-contained high-precision navigation of a mobile vehicle and position, navigation, and timing (PNT) within and across a network of independently maneuvering mobile vehicles.

### (2) Description of Related Art

Currently, there are several existing technologies for localizing a mobile vehicle within an environment. Existing technologies use sensors such as optical cameras, LiDAR (Light Detection and Ranging), acoustic sounders, radio frequency sounders, radar, sonar, or a combination of these. Each have their limitations and disadvantages. For example, optical cameras rely upon external illumination and cannot operate in fog or other inclement weather. While LiDAR provides its own illumination, likewise, its performance degrades in inclement weather. Existing technologies that employ acoustic sounders, radar and sonar provide their own illumination and are robust against weather and other environmental factors, but they lack sufficient accuracy.

Other technologies such as the Global Positioning System (GPS) provide position information by utilizing support systems external to the mobile vehicle. External support systems are not always available and can be intentionally or unintentionally blocked or otherwise corrupted. Furthermore, these systems do not inherently provide orientation information.

Existing Inertial Measurement Units (IMUs) provide location and orientation information, but they are prone to drift over time without an external mechanism to constrain the drift. Even the highest-quality IMUs drift over time and cannot maintain accuracy relative to the environment over longer terms.

In one known prior art system, an integrated Interferometric Synthetic Aperture Radar (SAR) aided Inertial Navigation System (InSAR/INS) operates based on interferogram matching. Terrain undulation and platform attitude can be reflected in the interferometric phase; hence, interferogram matching can provide location shift information. In this system, a single InSAR Interferogram is captured and compared to a Digital Elevation Model (DEM) reference.

Another system comprises a Distributed Array SAR system which combines interferograms with inertial measurements. This system addresses issues created from using multiple antennas distributed over an airplane wing which moves. The system requires a rigid baseline, combined with a flexible baseline, and integrates Motion Compensation (MOCO). Small low-precision inertial navigation sensors are fixed to the distributed antennas and used to measure relative movement. However, because of its low precision, a small INS cannot meet the demands of MOCO.

U.S. Pat. No. 6,677,885 to Franklot describes an Interferometric Synthetic Aperture Radar (INSAR) using a long and short baseline approach with a single antenna and multiple passes.

U.S. Pat. No. 10,823,844 to Arndt, describes a method of analyzing a vehicle's surroundings. The method includes the steps of arranging a first sensor group with at least two radar sensors on a vehicle, emitting radar waves into the vehicle's environment, reflecting the emitted radar waves on objects in the vehicle's environment, receiving the reflected radar waves using the radar sensors, identifying information about the vehicle's environment from the received radar waves and outputting the radar information. In order to improve the analysis of the carriageway environment, the radar sensors are arranged on the vehicle such that the emitted and received radar waves interfere. Radar information is obtained by taking account of the resulting interference data.

U.S. Patent Publication Number 2004/0227954 to Xie, describes an optical navigation device for determining movement relative to an object. The device includes a source of optical radiation for illuminating the object, and a detector for capturing phase patterns in the optical radiation after the optical radiation returns from the object. The phase patterns are correlated with optical non-uniformities of the object.

While the prior implementations described above demonstrate that the broad concept of using interferograms for position relative to the surrounding environment and gathering data about that environment along with combining or comparing the IMU data with the obtained interferometric data is generally known, these prior systems lack either a method to achieve precision positioning or they must rely on externally obtained datasets with which to perform comparisons.

### SUMMARY OF THE INVENTION

A novel, standalone navigational system is capable of highly precise three-dimensional location and three-dimensional orientation of a mobile vehicle, or multiple vehicles, within an environment without the need for external systems or inputs. The present disclosure achieves precision positioning (micron-level) without requiring any previously obtained datasets for comparison allowing this method to be used for navigation and positioning in previously unexplored regions such as subterranean caves or planets in the solar system Generally, the system is referenced as a position, navigation, and timing (PNT) system which is self-reliant, i.e. a Self-PNT system.

The system may include an active coherent imaging sensor array with multiple receivers that observe the surrounding environment and a digital processing component that processes the received signals and produces pair-wise interferometric images to determine the precise three-dimensional location and three-dimensional orientation of the vehicle or vehicles within that environment.

In this regard, in a first single-vehicle embodiment, the present disclosure describes a system having multiple receivers spaced within a two-dimensional (2D) array where the system computes interferograms across all pairs of receivers to estimate the error in navigation relative to the vehicle's expected navigation state, correcting and updating that state information in the process. The vehicle's expected navigation state is provided by means of forward propagation of the previous navigation solution. In another single-vehicle exemplary embodiment, the vehicle navigation state is supplemented by another method for concurrently measuring the position and orientation of the vehicle, such as measurements provided by an inertial measurement unit (IMU).

More specifically, a system for self-contained high-precision navigation comprises an active coherent imaging sensor array with multiple receivers that observes the surrounding environment. A digital processing component processes the received signals and produces interferometric images to determine the precise three-dimensional location and three-dimensional orientation of the system within that environment. The system employs a two-dimensional array of at least three receivers and at least one transmitter that are directed towards the surrounding environment. The two-dimensional array is connected to the digital processing unit. For mobile vehicles with low kinematic dynamics, this system may use only the receiver array and the digital processing unit with forward projection of the navigation state to sufficiently maintain the full navigation solution (Self-PNT). For vehicles with high kinematic dynamics, the system may further include an inertial measurement component, such as an IMU, which may be connected to the digital processing unit to provide a comparative navigation state.

The system operates by transmitting acoustic or electro-magnetic energy, via the transmitter, toward the environment. The environment reflects the transmitted energy which is coherently received by at least three receivers that are arranged in the two-dimensional array. As the mobile vehicle upon which the system is mounted moves, the transmitter continues to transmit, and the receivers continue to receive the reflected energy. The energy reflected from the environment is digitized at the receivers and sent to the digital processing unit.

Additionally, as the vehicle moves, either forward propagation of the navigation solution or concurrent inertial measurements provide information relating to the position and orientation of the vehicle-mounted array to the digital processing unit. Using this motion information and the information from the receivers, the digital processing unit creates coherent images of the environment from the received signals.

One image is created for each of the receivers. The created images are compared on a pair-wise basis and coherently interfered to produce pair-wise interferograms. One interferogram is produced for each pair-wise combination of receivers. The interferograms are then used to produce a precise estimate of the position and orientation error relative to the vehicle's expected position and orientation state. The vehicle's expected position and orientation state is based on the forward propagation of previous navigation solutions and/or the concurrent inertial measurement data. The interferogram-based position and orientation error estimates are used to precisely update the vehicle's location and orientation within the environment. The precision and accuracy of the receiver positioning is a small fraction (˜ 1/100) of the transmit signal's wavelength. This leads to micron-level localization and milli-degree orientation of the vehicle, which is a substantial improvement over other prior art approaches.

The system can be used in any environment where the objects and surfaces within that environment reflect sufficient energy to be received by the receivers, and a sufficient number of objects and surfaces distributed within that environment are stationary at the scale of the time it takes for one receiver within the array to move to the location of another receiver within the array. The system can be used at short distances such as inside a building or in a tunnel and can also be used at long distances such as from a satellite in orbit around the Earth or another planet. The system can further be used at all distances in between, such as on low-altitude drones, mid- and high-altitude aircraft, and stratospheric balloons. The system can also be employed underwater with acoustic transmitters and receivers (Sound navigation and ranging—Sonar). With appropriate scaling of the strength of the transmit energy and sensitivity of the receivers, the inventive system can be used across a broad range of environments and mobile vehicles or vessels.

In an exemplary method of operation, an IMU is part of the system and serves two functions. First, the IMU provides a means to initialize the navigation solution, e.g., initialize the orientation of the moving vehicle upon which the system is mounted. Second, the IMU provides a means to measure concurrent position and orientation that is used by the digital processing unit for image formation and is then updated with finer precision by the errors estimated from the collected interferograms. If an alternative means exists to initialize the navigation and an alternative means exists to estimate concurrent navigation information, the IMU can be removed from the system. In either case, the system provides a navigation solution relative to the initial position and orientation of the vehicle.

In another exemplary embodiment, the invention concerns the 3-D positioning of a network of independently maneuvering mobile vehicles in a common environment. Each vehicle hosts an active coherent imaging system and maintains a communications link with at least one other vehicle in the network. Each vehicle illuminates a common area of the environment in which the network of vehicles are operating and does so in coordination such that each vehicle can receive their own transmissions as well as the transmissions of the other vehicles. This allows both monostatic and bi-static imagery to be formed on each vehicle.

Each vehicle forms interferograms by coherently combining its own images with images from other vehicles as well as images produced bi-statically between two vehicles. The methods disclosed in the previous embodiment for a single vehicle system are used in a similar fashion to establish the relative 3-D positioning between the multiple vehicles operating in the network.

Accordingly, it is an object of the present disclosure to provide a self-contained navigational system using multiple receivers in a two-dimensional array to create pair-wise interferograms from each of the receivers for comparison with an expected position and orientation based on inertial measurement data. It is also an object of the present disclosure to provide the same self-contained navigational system without need of supporting inertial measurements, particularly for vehicles that exhibit low kinematic dynamics (e.g., an orbiting satellite). The present disclosure provides a navigational method and system that creates a unique interferogram from multiple receivers within a two-dimensional array to precisely update the vehicle's location and orientation within the environment.

It is another object to be able to utilize the self-contained navigation system in a network of independently maneuvering mobile vehicles.

These objectives, together with other objectives of the invention, along with various features of novelty which characterize the invention, are pointed out with particularity in the claims annexed hereto and forming a part of this disclosure.

For a better understanding of the invention, its operating advantages and the specific objectives attained by its uses, reference should be had to the accompanying drawings and descriptive matter in which there is illustrated a preferred embodiment of the invention.

### BRIEF DESCRIPTION OF THE DRAWING FIGURES

In the drawings which illustrate the best mode presently contemplated for carrying out the present invention:

FIG. 1 is a schematic illustration of a single-vehicle self-contained high-precision navigation system in accordance with an embodiment of the present disclosure;

FIG. 2 is a schematic illustration of the relationship between the reflected images captured by each receiver for pairwise computation of interferograms;

FIG. 3 is a schematic illustration of the manner in which the position errors of the receive channels determined from the interferograms are employed to estimate roll, pitch and yaw information of the vehicle;

FIG. 4 is a schematic illustration of a network of independently maneuvering mobile vehicles illuminating a common area within the surrounding environment 230;

FIG. 5 is a schematic illustration of communication links between N mobile vehicles which form a network of mobile vehicles;

FIG. 6 is an illustration of the varying degrees of freedom and error adjustments utilized within the single-vehicle and multi-vehicle embodiments;

FIG. 7 is an illustration of a prior art INS/GNSS Architecture for navigation; and

FIG. 8 is an illustration of an exemplary embodiment of a Self-PNT navigation architecture utilizing the system and methods of the present invention.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

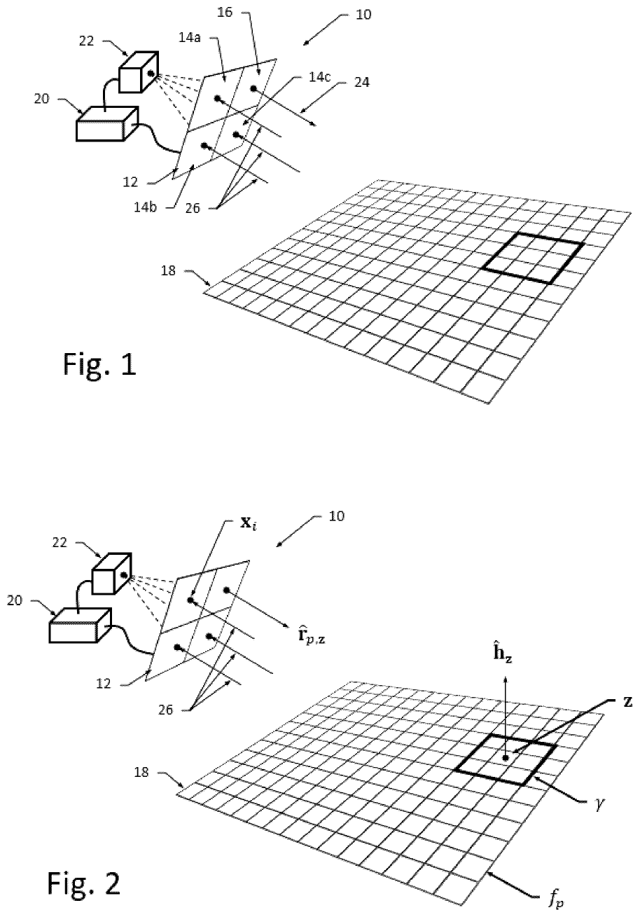

Referring to drawings FIGS. 1-3, a system of self-contained high-precision navigation of a single-vehicle is shown and generally indicated at 10. Generally, the system employ a two-dimensional transmitter/receiver array that observes the surrounding environment and a digital processing component that processes the received signals and produces interferometric images to determine the precise three-dimensional location and three-dimensional orientation of the system within that environment.

In an exemplary embodiment as illustrated, the system 10 employs a two-dimensional array of at least three receivers and at least one transmitter that are directed towards the surrounding environment. In another exemplary system and method, an inertial measurement unit (IMU) is also connected to the digital processing unit.

Referring now to FIG. 1, a first exemplary embodiment of a single-vehicle Self-PNT system 10 generally comprises a two-dimensional array 12 of at least three receivers 14a, 14b, 14c and at least one transmitter 16. The fixed two-dimensional array 12 is mounted or supported in a manner such that the array 12 is directed towards the surrounding environment 18. The two-dimensional array 12 is connected to a digital processing unit 20. An IMU 22 is also connected to the digital processing unit 20 in a position that is fixed relative to the array 12.

The system 10 transmits acoustic or electro-magnetic energy 24, via the transmitter 16, towards the environment 18. The environment 18 reflects the transmitted energy wherein the reflected energy 26 is coherently received by the at least three receivers 14a, 14b, 14c that are arrayed in the two-dimensional array 12. As the mobile vehicle upon which the system 10 is mounted moves, the transmitter 16 continues to transmit energy 24, and the receivers 14a, 14b, 14c continue to receive the reflected energy 26 (continuous scan). The reflected energy 26 from the environment 18 is captured and digitized at the receivers 14a, 14b, 14c and sent to the digital processing unit 20.

Additionally, in some embodiments of the invention, the IMU 22 detects acceleration and rotation rate information relating to the position and orientation of the vehicle mounted array 10 and transmits this information to the digital processing unit 20 as the vehicle moves. The accuracy of the IMU measurements can be coarse in quality. Using the information from the receivers 14a, 14b, 14c and the IMU 22, the digital processing unit 20 creates coherent snapshot images of the environment 18 from the digitized reflected energy 26 collected at the receivers 14a, 14b, 14c as modified using the acceleration and rotation rate data from the IMU 22.

In an exemplary method, one image is created for each of the receivers. The created images are compared to one another on a pair-wise basis and coherently interfered to produce interferograms. One interferogram is produced for each pair-wise combination of receivers 14a, 14b, 14c. The interferograms created from the reflected energy 26 detected from the environment 18 are then used to produce an estimate of the error in vehicle position and orientation relative to the vehicle position and orientation reported by the IMU 22. The errors are then used to precisely update the vehicle's location and orientation within the environment 18. The precision and accuracy of the localization computed is a small fraction (˜ 1/100) of the transmit signal's wavelength which enables micron-level positioning and milli-degree orientation and achieves improved localization performance over other approaches.

The same process can be applied to a system without an IMU 22 using forward propagation of previous navigation solutions to provide estimates of the vehicle's expected position and orientation within the environment 18 for use in the interferogram-based corrections, as long as the kinematic dynamics are low. For situations of high kinematic dynamics, the same process used with the IMU 22 can be applied to a system without an IMU 22 as long as there is an alternative means to provide some level of position and orientation estimates for use in the interferogram-based corrections, i.e. a secondary position/orientation input.

The system 10 of the present disclosure can be used in any environment 18 where objects and surfaces within the environment 18 reflect enough energy to be received by the receivers 14a, 14b, 14c, and a sufficient number of objects and surfaces distributed within that environment are stationary at the scale of the time it takes for one receiver within the array to move to the location of another receiver within the array. The system 10 can be used at short distances such as inside a building or in a tunnel as well as for far distances such as from a satellite in orbit around the Earth or another planet. The system can further be used at all distances in between, such as on low-altitude drones, mid- and high-altitude aircraft, and stratospheric balloons. The system can also be employed underwater with acoustic transmitters and receivers (Sound navigation and ranging—Sonar). With appropriate scaling of the strength of the transmit energy and sensitivity of the receivers, the system 10 can be deployed for use in conjunction within a broad range of environments and vehicles or vessels. It should be appreciated by one skilled in the art that an exhaustive list of environments and vehicles need not be listed as the system 10 is self-contained and intended to operate in a standalone manner thereby being unlimited in its deployment relative to vehicles and environments.

Turning now to FIG. 2, images are formed from the digitized reflected energy 26 using the synthetic aperture technique known as backprojection. This technique directly incorporates the locations of each receive phase-center represented by xᵢ and the assumed locations of the objects and surfaces from which the reflected energy 26 is gathered from the environment 18. Backprojection calculates the signal received at a phase-center for the i^{th} pulse as a function of range, r, denoted as sᵢ(r), and is formulated as:

$${I}_{z} = {\sum }_{i = 1}^{N} {s}_{i} ( ‖ {x}_{i} - z ‖ ) \cdot {e}^{j 4 π ‖ {x}_{i} - z ‖ / λ}$$

wherein:
I_{z}—represents the environmental response,
sᵢ(r)—represents signal received at a phase-center,
r=∥xᵢ−z∥,
xᵢ—represents the time-evolving phase center location in three-dimensional space,
z—represents a pixel being observed in the environment, and
λ—represents the wavelength of the propagating energy.

To determine the complex environment response, I_{z}, the signal from range location r=∥xᵢ−z∥ is summed over a set of N pulses, and the collection of these responses for the p^{th} receive phase-center over all pixel locations constitutes the coherent image for that receive phase-center, denoted as fₚ.

Once the coherent images have been formed for all the receive phase-centers, interferograms are computed between all pairwise combinations of phase-centers. Each interferogram is computed using the complex cross correlation coefficient for a pair of coherent images fₚ and f_{q}:

$$γ = \frac{{\sum }_{m = 1}^{M} {f}_{p} ( m ) {f}_{q}^{*} ( m )}{\sqrt{{\sum }_{m = 1}^{M} {\vert {f}_{p} ( m ) \vert}^{2} \cdot {\sum }_{m = 1}^{M} {\vert {f}_{q} ( m ) \vert}^{2}}} ,$$

where ⋅* indicates complex conjugation. This coefficient is computed across the image over a neighborhood of M pixel locations where M is chosen based on the desired signal-to-noise ratio in the resulting interferometric phase.

The interferometric phase for the pq^{th} phase-center pair at pixel location z, denoted as ϕ_{pq,z}, is described precisely with the following equation:

$${ϕ}_{pq , z} \frac{λ}{4 π} = [ {ε}_{p} \cdot {\hat{r}}_{p , z} - {ε}_{q} \cdot {\hat{r}}_{q , z} + {δ}_{z} {\hat{h}}_{z} \cdot ( {\hat{r}}_{p , z} - {\hat{r}}_{q , z} ) ]$$

where εₚ and ε_{q} are the position errors associated with the p^{th} and q^{th} phase-centers respectively. The unit vectors \hat{r}_{p,z} and \hat{r}_{q,z} point from the p^{th} and q^{th} phase-centers to the pixel location z. The unit vector ĥ_{z} is the height direction at pixel location z, and, finally, δ_{z} represents the height error at this pixel location.

Based on the above calculations, an interferometric phase measurement is produced for each pixel location and each pairwise combination of receive phase-centers. These interferometric phase measurements constitute an overdetermined system of equations that is used to solve for the phase-center position errors and the pixel height errors using the method of least squares. Since the noise in the phase measurements is Gaussian, this approach is the Best Linear Unbiased Estimate (BLUE) of the phase-center position and pixel height errors. To maintain a unique solution, the first phase-center is assumed to have no errors, resulting in estimation of phase-center errors that are relative to the first.

The orientation and position error of the vehicle is then determined based on the estimated phase-center position errors. First, the expected phase-center positions, determined either from inertial measurements or forward propagation of prior navigation solutions, are corrected by the BLUE-estimated phase-center errors. The three-dimensional distance between the centroids of the expected and corrected phase center positions establishes the three-dimensional position error of the vehicle.

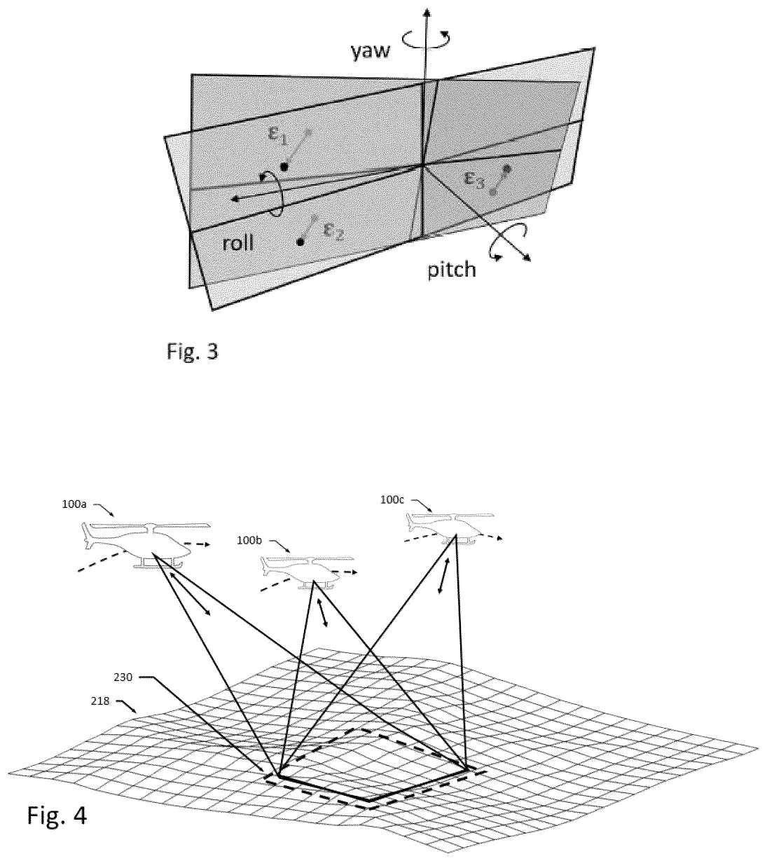

Turning now to FIG. 3, the Kabsch algorithm is used to estimate the roll, pitch, and yaw rotation angles between the expected phase-center positions and the corrected phase-center positions. The result is the three-dimensional orientation error of the vehicle. These estimated vehicle orientation errors are then used to update the vehicle's complete navigation solution.

This system and method can be used in any environment where the objects and surfaces within that environment reflect enough energy to be received by the receivers, and a sufficient number of objects and surfaces distributed within that environment are stationary at the scale of the time it takes one receiver within the array to move to the location of another receiver within the array. For example, the ocean surface is a moving environment, but electro-magnetic energy reflected from that surface is substantially the same as electro-magnetic energy reflected from that surface a short time later, when the trailing receiver views the same scene. With receivers arrayed appropriately to mitigate the impact of the motion, the system can operate within this type of moving environment. Similarly, the system can be used at short distances such as inside a building or in a tunnel and can also be used at far distances such as from a satellite in orbit around the Earth or another planet. With appropriate scaling of the strength of the transmit energy and sensitivity of the receivers, the invention can be used across a broad range of environments and vehicles.

In one of the preferred methods of operation, an IMU is part of the system and serves two functions. First, the IMU provides a means to initialize the navigation solution, e.g., initialize the orientation of the moving vehicle upon which the system is mounted. Second, the IMU provides a means to measure concurrent position and orientation that is used by the digital processing unit for image formation and is then updated with finer precision by the errors estimated from the collected interferograms. If an alternative means exists to initialize the navigation and an alternative means exists to estimate concurrent navigation information, the IMU can be removed from the system. In either case, the system provides a navigation solution relative to the initial position and orientation of the vehicle.

Using coherent images from an array of active sensors to form interferograms of the environment and updating a navigation solution for a vehicle is believed to be a novel and unique aspect of this disclosure. As such, the system employs an active radar or acoustic sensor array to coherently image the surrounding environment. The coherent imaging step and the processing of those coherent images provides orders-of-magnitude improved localization and orientation accuracy beyond existing technologies. For example, because the localization precision is on the order of a small fraction of the transmission wavelength, and wavelengths are typically centimeters or less, micron-level localization and milli-degree orientation are possible.

Referring now to FIGS. 4-8, in another exemplary embodiment, the present disclosure provides for the 3-D positioning across a network of independently maneuvering mobile vehicles in a common environment. This will be referred to as a Mesh-PNT system and method.

As seen in FIGS. 4 and 5, each vehicle 100a, 100b, 100c, 100d hosts its own active coherent multi-channel imaging system 10 including an IMU as described hereinabove, to maintain its own self-positioning, and maintains a communications link 250 with at least one other vehicle 100 with in the network for transmitting and receiving signals for determining the 3-D position of the respective mobile vehicle 100 within the network of mobile vehicles.

Still referring to FIG. 4, each vehicle 100 illuminates a common area 230 of the environment 218 in which the network of vehicles are operating and does so in coordination such that each vehicle 100 can receive their own transmissions as well as the transmissions of the other vehicles 100. This allows both monostatic and bi-static imagery to be formed on each vehicle.

Each vehicle forms interferograms by coherently combining its own images with images from other vehicles as well as images produced bi-statically between two vehicles. The methods disclosed in the previous embodiment for a single vehicle system are used in a similar fashion to establish the relative 3-D positioning between the multiple vehicles operating in the network. However, because of the introduction of a slight communication time lag between the relative vehicles 100a, 100b, etc., a timing error adjustment must be taken into account. In this regard, the interferometric phase for the pq^{th} phase-center pair at pixel location z, denoted as ϕ_{pq,z}, is described with the following equation which now includes a timing error:

$${ϕ}_{pq , z} \frac{λ}{4 π} = [ {ε}_{p} \cdot {\hat{r}}_{p , z} - {ε}_{q} \cdot {\hat{r}}_{q , z} + {δ}_{z} {\hat{h}}_{z} \cdot ( {\hat{r}}_{p , z} - {\hat{r}}_{q , z} ) + c ( {τ}_{p} - {τ}_{q} ) ]$$

where τₚ and τ_{q} are the timing errors for the p^{th} and q^{th} channels respectively, and as before, εₚ and ε_{q} are the position errors associated with the p^{th} and q^{th} phase-centers and the unit vectors \hat{r}_{p,z} and \hat{r}_{q,z} point from the p^{th} and q^{th} phase-centers to the pixel location z. The unit vector ĥ_{z} is the height direction at pixel location z, and, finally, δ_{z} represents the height error at this pixel location.

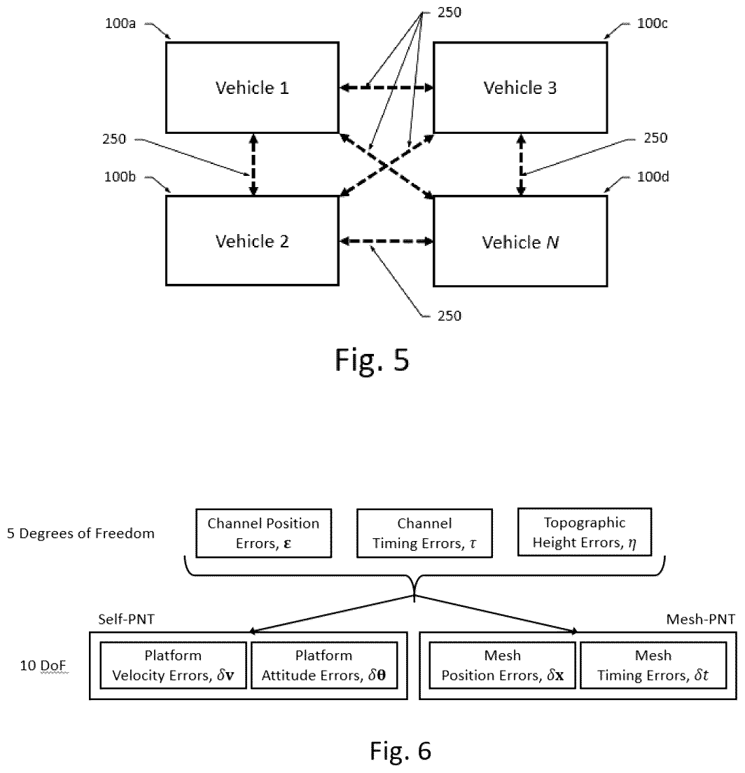

Referring to FIG. 6, an illustration of the varying degrees of freedom as used within the Self-PNT system and the Mesh-PNT system, the fundamental degrees-of-freedom measured by the phase equation just above are channel position errors, channel timing errors, and topographic height errors (five degrees-of-freedom). From these fundamental measurements, in the single-vehicle embodiment, 3-D platform velocity errors and 3-D platform attitude errors are derived (six degrees-of-freedom) for Self-PNT. In the multiple-vehicle embodiment, these fundamental measurements are used to derive the 3-D position errors between the vehicles and the timing errors between the vehicles in the mesh (four degrees-of-freedom) for Mesh-PNT. In total, there are then ten degrees-of-freedom.

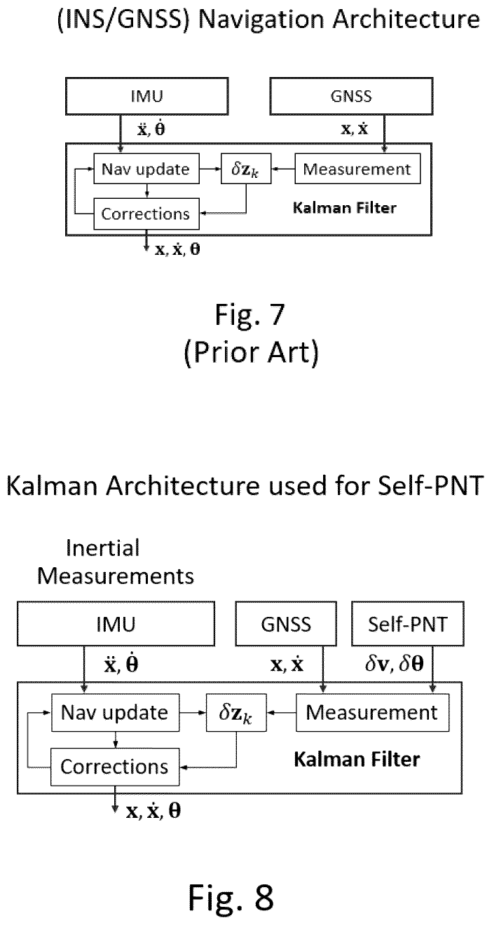

FIGS. 7 and 8 illustrate the differences between a traditional prior art Inertial Navigation System/Global Navigation Satellite System (INS/GNSS) navigation architecture (FIG. 7) and a Kalman architecture used for Self-PNT (FIG. 8) according to the present single- and multi-vehicle systems. The present system and method may utilize IMU measurements along with GNSS position and velocity if they are available along with its own Self-PNT for high-precision positioning. When GNSS position and velocity is available, the present invention improves the accuracy of the resulting navigation solution. When GNSS position and velocity are unavailable for whatever reason, the present invention enables continued high accuracy navigation than would otherwise be possible with IMU navigation alone or even continued high accuracy navigation without IMU or GNSS.

In an alternate embodiment and methodology, each mobile vehicle 100a, 100b, 100c, 100d hosts an active coherent single-channel imaging-based sensor array system 10 and may, or may not, have an IMU to maintain its own self-positioning. In this embodiment, only the 3-D positions of the mobile vehicles within the network of mobile vehicles are determined.

It should be appreciated that the disclosed system is a self-contained mechanism such that the operation is entirely under the control of the user and no coordination or communication with external support systems, like GPS, is required. This property enables robust operation in environments that block or otherwise interfere with external support systems. This allows the system to provide a continuous estimate of localization and orientation relative to the environment, provided the system maintains acoustic or electro-magnetic contact with the environment. These features ensure that the localization and orientation of the system relative to the environment is well maintained.

While the present disclosure illustrates or discusses airborne or spaceborne vehicles utilizing radar arrays, the presently described single vehicle and multiple vehicle network systems and methods are equally applicable to underwater applications implemented with sonar arrays.

It can therefore be seen that the present disclosure provides a self-contained navigational system using multiple receivers in a two-dimensional array that creates pairwise interferograms from each of the receivers to precisely correct the position and orientation estimates based on inertial measurement data or based on forward propagation of previous navigation solutions. Further, the present disclosure provides a navigational method and system that creates a unique interferogram from multiple receivers within a two-dimensional array to precisely update the vehicle's location and orientation within the environment.

When expanded to a multiple vehicle network system, the systems provide a novel mesh architecture to determine the precise three-dimensional location of each mobile vehicle relative to the others operating and moving within the network. For these reasons, the present disclosure is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for relative navigation of a mobile vehicle within a network of independently maneuvering mobile vehicles, comprising:
a plurality of navigation systems wherein each respective navigation system is hosted on one of a plurality of independently maneuvering mobile vehicles operating in a common environment; and
a communication system operating between the respective navigation systems;
each navigation system comprising:
a transmitter;
a two-dimensional receiver array including at least three receivers,
said transmitter directing energy at said common environment, said environment reflecting energy back to said at least three receivers, said at least three receivers capturing and digitizing said reflected energy; and
a digital processing unit in communication with said transmitter and said two-dimensional receiver array,
for each navigation system, said digital processing unit creating a coherent two-dimensional image from the digitized reflected energy captured by each of said three receivers,
each of said plurality of navigation systems distributing said created two-dimensional images to the other of said plurality of navigation systems,
each of said plurality of navigation systems selectively producing a plurality of two-dimensional interferograms from a plurality of pair-wise combinations of said created coherent two-dimensional images,
each of said plurality of navigation systems further processing the plurality of two-dimensional interferograms to produce estimates of error of the position and orientation of the mobile vehicle relative to the expected system position and orientation and incorporating said errors into a navigation solution of said mobile vehicle.

2. The system of claim 1, wherein said system is continuously creating and processing said two-dimensional coherent images, continuously producing said two-dimensional interferograms in pair-wise combinations, continuously producing error estimates and continuously incorporating said errors into successive navigation solutions for said mobile vehicle as a position of said mobile vehicle changes.

3. The system of claim 1, wherein each of said plurality of navigation systems further comprises:
an inertial measuring unit positioned in fixed position relative to said two-dimensional receiver array and in communication with said digital processing unit, said inertial measuring unit detecting acceleration and rotation rate information relating to the expected position and orientation of the system and transmitting said information to the digital processing unit.

4. The system of claim 3, wherein said digital processing unit uses said interferograms to produce an estimate of the error in system position and orientation relative to the system position and orientation reported by said inertial measurement unit, and
wherein said estimates of position and orientation error are applied to the said position and orientation reported by the inertial measurement unit to precisely update the system position and orientation within the environment.

5. A method for relative navigation of a mobile vehicle within a network of independently maneuvering mobile vehicles, comprising the steps of:
providing a plurality of navigation systems wherein each respective navigation system is hosted on one of a plurality of independently maneuvering mobile vehicles operating in a common environment,
each navigation system comprising:
a transmitter;
a two-dimensional receiver array including at least three receivers; and
a digital processing unit in communication with said transmitter and said two-dimensional receiver array;
providing a communication system operating between the respective navigation systems;
for each navigation system, said transmitter directing energy at said common environment, said environment reflecting energy back to said at least three receivers, said at least three receivers capturing and digitizing said reflected energy,
for each navigation system, said digital processing unit creating a coherent two-dimensional image from the digitized reflected energy captured by each of said three receivers,
each of said plurality of navigation systems distributing said created two-dimensional images to the other of said plurality of navigation systems,
each of said plurality of navigation systems selectively producing a plurality of two-dimensional interferograms from a plurality of pair-wise combinations of said created coherent two-dimensional images, and
each of said plurality of navigation systems further processing the plurality of two-dimensional interferograms to produce estimates of error of the position and orientation of the mobile vehicle relative to the expected system position and orientation and incorporating said errors into a navigation solution of said mobile vehicle.

6. The method of claim 5, further comprising the steps of continuously creating and processing said two-dimensional coherent images, continuously producing said two-dimensional interferograms in pair-wise combinations, continuously producing error estimates and continuously incorporating said errors into successive navigation solutions for said mobile vehicle as a position of said mobile vehicle changes.

7. The method of claim 5, wherein each navigation further comprises:
an inertial measuring unit positioned in fixed position relative to said two-dimensional receiver array and in communication with said digital processing unit, and wherein the method further comprises the steps of
detecting with said inertial measuring unit acceleration and rotation rate information relating to the expected position and orientation of the system and transmitting said information to the digital processing unit.

8. The method of claim 7, wherein said digital processing unit uses said interferograms to produce an estimate of the error in position and orientation relative to the position and orientation reported by said inertial measurement unit, and
wherein said estimates of position and orientation error are applied to the said position and orientation reported by the inertial measurement unit to precisely update the position and orientation of the two-dimensional array within the environment.
